(19) United States
(12) Patent Application Publication
(10) Pub. No.: US 2015/0125646 A1
(43) Pub. Date: May 7, 2015

(54) Self-Healing Thermally Conductive Polymer Materials

(71) Applicant: ESPCI Innov, Paris (FR)

(72) Inventors: Francois Tournilhac, Paris (FR); Ludwik Leibler, Paris (FR); Jacques Lewiner, Saint Cloud (FR); Ugo Lafont, Den Haag (NL); Sybrand Van Der Zwaag, Schipluiden (NL); Henk Van Zeijl, Gravenzande (NL)

(21) Appl. No.: 14/072,276

(22) Filed: Nov. 5, 2013

(51) Int. Cl. C09K 5/14; B32B 27/06; B32B 27/36; B32B 15/09

(52) U.S. Cl. CPC C09K 5/14; B32B 15/09; B32B 27/06; B32B 27/36; B32B 2250/02; B32B 2307/302; B32B 2439/00; B32B 2581/00; B32B 2457/00
USPC 428/36.92; 252/76; 252/75; 428/458

(57) ABSTRACT

Thermally conductive polymer materials having thermally conductive charges and polymer network compositions characterized by the fact that the network is able to reorganize by exchange reactions that allow it to relax stresses and/or flow while maintaining network connectivity. As a result, the polymer network is characterized by its finite viscosity at elevated temperatures in spite of the crosslinking. These characteristics provide such materials remarkable properties for use as thermal interface and notably improved adhesion, self-repairing, in addition to greater processing flexibility, better mechanical properties, improved chemical resistance.

### FIELD

The invention relates to novel thermally conductive polymer materials comprising thermally conductive charges and polymer network compositions characterized by the fact that the network is able to reorganize by exchange reactions that allow it to relax stresses and/or flow while maintaining network connectivity. As a result, the polymer network is characterized by its finite viscosity at elevated temperatures in spite of the crosslinking. These characteristics provide such materials remarkable properties for use as thermal interface and notably improved adhesion, self-repairing, in addition to greater processing flexibility, better mechanical properties, improved chemical resistance.

### BACKGROUND

Thermal interface materials (TIM) are widely used when the thermal conductance between two joint surfaces needs to be increased. Thermally conductive polymer compositions are of interest as TIM in a number of applications. Such is the case for example, in microelectronic and optoelectronic devices such as semiconductors, microprocessors, resistors, circuit boards and integrated circuit elements, in motor parts, energy transfer equipment, lighting fixtures, optical heads, medical devices.

It is expected from such materials that they present high thermal conductivity, and for this reason significant amounts of thermally conductive fillers must be incorporated. In some cases it is also expected that they are electrically insulating.

However, material degradation like cracking and delamination may occur under expansion and contraction due to temperature cycling. When in use, such materials are submitted to temperature variations, which, when repeated, degrade the polymer matrix. Defaults, including cracks and gas bubbles, appear, degrading the matrix cohesiveness. Such defaults significantly limit the life time of thermally conductive polymer materials. In addition to the temperature variation cycles, the presence of thermally conductive charges in the polymer matrix, resulting in a heterogeneous composition, is an aggravating factor to this phenomenon. The device service life is intimately related to the efficiency and reliability of the thermal management. In this respect, a reliable thermal management will insure to minimize the effect of thermal stress on the device degradation and thus increase its service life.

Another difficulty encountered when formulating thermally conductive polymer compositions is their lack of affinity with metals, to which they are frequently associated. Notably, in electric cable applications, thermally conductive, electrically isolating, polymer materials are used as an insulating sheath between two metal layers, especially copper or aluminium layers. The lack of affinity of polymer materials with metals results in poor contact between the polymer surface and the metal surface, and reduces the heat transfer capacity of the sheath. In the field of automotive industry, there is also a need for coatings applicable to engine parts that would have good adhesiveness to metal, elevated heat transfer capacity, and thermal expansion similar to that of metal. Frequently, thermally insulating polymer coatings applied on metals tend to crack and delaminate on account of different thermal expansion factors in metals and in polymers.

Thermal pads used in the electronics and electric industry also need to present good adhesiveness to metals. Thermal pads of the prior art are based on silicon resins in composite formulation with thermally conductive fillers. They have the inconvenient of being fragile, and not reparable. They are formulated to be adhesive and for this reason must be manufactured with a protective liner. Thin films of thermally conductive silicone composites have a non-negligible thermal resistance and suffer from fragility. An alternate solution is to use grease wherein thermally conductive fillers have been dispersed. However, such grease films have poor mechanical properties and tend to leak when heated, which results in pumping out of fillers and loss of efficiency. Both prior art solutions suffer from degradation of properties upon use.

In the field of direct current transport, particularly in high voltage applications, there is also a need for thermally conductive, electrically isolating, polymer materials with high thermal transfer capacity, high mechanical strength, resistance to cracks and failures.

In the field of microelectronics, the conception of integrated circuit designs has evolved towards higher operating frequency, increased numbers of transistors, and physically smaller devices. Microelectronic devices are characterized by increasing area densities of integrated circuits and electrical connections. Further, materials used in electronic packaging generally have different coefficients of thermal expansion. Under temperature fluctuations induced by normal usage, storage, and manufacturing conditions, the various coefficients of thermal expansion may lead to mechanical failures such as material cracking (cohesive failure) and delamination in a region of adjoining materials (adhesive failure). Mechanical failures may further be induced by many other causes, like exposure to shock and vibration. Thus, there is a need for materials capable of forming a chassis structure for electrical and electronic devices, sufficiently thermally conductive to dissipate the heat generated in these devices while retaining their mechanical properties. Moreover, in the same technical field, bare die package assembly and testing procedures are the source of many potential defects: manual handling of piece parts and media, tool contact with the die backside, test pedestal scratching, and so forth. All of these sources, and others, lead to die crack fails either during manufacture or in reliability testing. Thus, there is a need of a material that could be applied as a thin and highly thermally conductive coating layer, would provide high scratch resistance and enable effective heat removal from the die.

In all the above-mentioned applications, there is a need for a material with an improved thermal transfer capacity, self-repairing properties, therefore, longer lasting. In some applications good affinity with metal is required, as well as adaptability to the thermal expansion of other materials to which they are associated. The ability of a TIM to conform to the surface of other materials to which it is associated would be an improvement in some thermal transfer equipment.

In the field of thermal interface composite materials, two classes of materials may be schematically distinguished as a function of the type of resin used as matrix: composites with a thermoplastic matrix and composites with a thermosetting matrix.

Thermoplastic resins are non-crosslinked polymers such as polyethylene or PVC. These resins may be processed and optionally reprocessed at high temperature and have a good ability to conform to a surface. However, under service conditions, they have to operate at relatively high temperatures and then, they have the drawback of having poor mechanical properties and tendency to leak, which results in pumping out of fillers and loss of efficiency. Moreover, due to the presence of plasticizers, the harmlessness and the long-term stability of these materials is not satisfactory either.

Thermosetting resins are crosslinked polymers. They are, for example, epoxy resin formulations. These resins are processed before crosslinking starting with precursors that are low-viscosity liquids. They have the advantage of having high fluidity before crosslinking, which facilitates the impregnation of fillers or fibres for the manufacture of composites. They also have very good thermal resistance and mechanical strength and also good resistance to solvents. However once the crosslinking reaction is achieved, there is no possibility to change the shape of the obtained composite article and in particular, it is impossible to conform to a surface and achieve good thermal transfer without applying pressure. Among thermosetting polymers, mention may be made of unsaturated polyesters, phenoplasts, polyepoxides, polyurethanes and aminoplasts. On the other hand, thermosetting polymers also have the drawback of not allowing the recycling of the resin after reaction.

WO2011/151584 and WO2012/152859 disclose thermosetting polymer networks, based respectively on epoxy resin and on a combination of epoxy resin and reactive H-bonding molecules, both crosslinked by mixtures of di- and tri-acids. The polymer networks disclosed in these documents contain a catalyst, which promotes transesterification reactions upon application of heat. Reparation, reforming and recycling of these materials is possible. These documents mention the possibility to use fillers in the polymer systems in a general manner.

To improve thermal conductive characteristics of polymer materials, it has been the conventional practice to add thermally conductive materials to polymer compositions. High volume contents of fillers are needed to achieve thermal conductivities suitable for efficient heat transport through a polymer composite.

It is often difficult to add thermally conductive fillers in large amounts to polymer compositions, because of their low bulk density as compared to that of polymers, because of their small size which tends to favor aggregation and their lack of chemical affinity for the resins. Even if the filler is uniformly dispersed, the filler material is not generally sufficiently wet out by the resin and adhesion between the inert surfaces of the filler particles and the polymer tends to be poor. These small particles may cause the resin to dust. Additionally, when these thermally conductive fillers are added to a base polymer, the modulus of the composition tends to increase, resulting in a more brittle composition. The addition of large quantities of fillers also tends to provoke the apparition of cracks and failures when the material is submitted to mechanical stress or temperature variations. Thermal transfer capacity of a polymer matrix can vary according to the phase state of the polymer matrix, therefore, the temperature of use may significantly influence the thermal transfer capacity of a polymer matrix.

WO2008/005399 discloses a thermosetting polymer containing nanoparticulate fillers forming a composite. The presence of nanoparticulate fillers ensures enhanced adhesion of the composite over prior art filler-containing composites. On account of their small size, these sealers may self-heal small cracks by migration of the nanoparticle through the polymer matrix. These self-healing composites may find application in microelectronics packaging.

However the use of these nanoparticulate fillers is of limited interest because, on account of their small size, they are difficult to disperse and they significantly increase the viscosity of the polymer composition. The ability of nanoparticles to migrate inside the matrix is limited by jamming at overall high concentrations of filler. The use of nanoparticulate fillers requires specific equipment and safety measures. And repairing by this mechanism is limited to nano-size defects, and therefore does not provide long term advantages.

U. Lafont et al., Asian-Australian Conference on Composite Materials, 6-8 Nov. 2012, have disclosed composites based on thermally conductive fillers in a polysulfide based thermoset matrix with self-healing properties. The matrix used contained 7 to 9.5 percent by weight of disulfide bonds. Adhesion and self-healing characteristics vary with the nature of matrix and amount of filler, with a maximum value for each type of matrix and a rapid degradation upon filler percentage increase. However, adhesion does not exceed 6 Kg·cm², and self-healing is not compatible with high amounts of filler. The matrix deteriorates when heated at or above 100° C., which is not compatible with most applications. And finally, the presence of disulfur bonds provides an unpleasant odor to the resin which precludes its use on industrial scale and in most applications.

The inventors have now discovered that when thermally conductive charges are incorporated into polymer network compositions based on polyester bonds characterized by the fact that the network is able to reorganize by exchange reactions while maintaining network connectivity, inconvenience of the prior art thermally conductive polymer materials are surmounted.

This solution has the advantage that classic thermally conductive fillers can be used. The filler has better affinity with the polymer matrix, notably filler wetting by the polymer matrix is improved. The material provides adaptability to other materials of varied thermal expansion coefficient, including metals, even when the material is applied as a thin coating. When submitted to temperature increase, the material has the capacity to repair defects which appear in the polymer matrix. Therefore, the material regenerates upon use, and aging signs, like cracks, gas bubbles and failures, are significantly reduced. Upon temperature increase, the material adapts to better fit with, or conform to, the surface of other materials with which it is contacted, resulting in improved thermal transfer. Upon temperature increase, the material develops adhesiveness, notably it shows adhesion to all kinds of supports, like metals, glass, aluminium, silicium. Contrarily to prior art material, adhesiveness does not vary much with filler percentage. Adhesion remains after temperature decrease. This permits manufacturing the material without necessity for a protective liner and provides better manipulation ability. Adhesion provided by the composite materials according to the invention is significantly higher as compared to prior art heat-activated adhesive composites and can be finely tuned by an appropriate selection of monomers. Self-healing properties are obtained even when high amounts of fillers are present in the composite. Surprisingly, the material can be submitted to higher temperatures than prior art thermally conductive polymer materials without degrading. This property permits improvements in energy transport: current transport is limited for cables of a given section due to the Joule effect which produces temperature rises. Such temperature increases must be limited by the heat-dissipation capacity of the material used as electrical insulator. In addition, materials of the invention, since they better fit with, or conform to, the surface of materials to which they are associated, provide increased heat-dissipation capacity and also for this reason, permit the transport of current of higher intensity. All these advantages are unexpected improvements as compared to prior art thermally conductive polymer materials.

In addition, the material presents the advantages already disclosed for polymer networks able to reorganize by exchange reactions. Thermally conductive polymer compositions of the invention can be reshaped and recycled and articles made of these compositions can be repaired. Polymer networks used in the invention are also characterized by a glass transition temperature Tg. These features, which are described in more detail below, can be adjusted to modulate mechanical and thermal properties of the polymer network. In all cases, the polymer composition's processability is improved: the polymer compositions can have more flexible and controlled modes of transformation

The compositions of this invention can be formed into an article of manufacture. The compositions and articles herein can be used in heat or thermal dissipation management applications, and especially where electrical insulation is required. Examples include, but are not limited to, heat sinks for electronic components in computers, thermal pads in electronics and electric devices, consumer electrical appliances, solar cells and batteries, such as processors, lamps, LED-lamps, electric motors, thermic motors, electric circuits, the encapsulation of electronics, such as coils or casings, solar cell back sheets, battery casings, heat exchangers, energy transfer applications like heat exchangers in transformers, electrically insulating sheath for electric cables, and also as thermal interface coatings.

Interestingly to these ends, the composite material of the invention can be delivered in elementary shapes like disks, boards, bars, cylinders (hollow or not), as well as laminates made up of several layers of different compositions which may be in turn cut to the adequate size and eventually reshaped to produce the desired article.

### SUMMARY

The object of the present invention is to alleviate at least partly the above mentioned drawbacks of thermally conductive polymer compositions of the prior art.

The Invention is Related to:

A polymer composition comprising:
a) a thermally conductive filler having thermal conductivity superior or equal to 5 W/mK,
b) a covalently crosslinked polymer network including connecting ester bonds, and
c) at least a transesterification catalyst,

wherein the amount of thermally conductive filler is sufficient for the composition to have thermal conductivity superior or equal to 0.5 W/mK, crosslinking is sufficient for the polymer network to be beyond the gel point and the number of connecting ester bonds is sufficient for the network to relax stresses and/or flow when conditioned at an appropriate temperature.

Preferred embodiments comprise one or more of the following features:

Advantageously, the polymer network comprises less than 4% by weight of groups selected from —S—S— (disulfur) and —(S)ₙ— (polysulfur, n>2) bridges.

According to favorite embodiments, the invention is directed to polymer compositions which satisfy one or several of the following characteristics:

The polymer composition, wherein the thermally conductive filler is electrically insulative, preferably the thermally conductive filler is selected from: aluminum nitride, boron nitride, magnesium silicon nitride, silicon carbide, ceramic-coated graphite, and combinations thereof.

The polymer composition, wherein the composition comprises from 5% to 80% by volume of a thermally conductive filler, preferably from 10% to 60% by volume with regards to the volume of polymer network.

The polymer composition, wherein the polymer network comprises hydrocarbon chains comprising connecting ester bridges, ether bridges, OH groups, and associative groups, and wherein hydrocarbon chains, connecting ester bridges, ether bridges, OH groups, and associative groups represent at least 60% by weight of the weight of the polymer network.

The polymer composition, wherein the polymer network consists essentially in hydrocarbon chains including connecting ester bridges, preferably the polymer network further includes ether bridges, OH groups, and associative groups.

The polymer composition, wherein the polymer network including connecting ester bonds is obtained by contacting:

At least one thermosetting resin precursor (P), this thermosetting resin precursor (P) comprising hydroxyl functions and/or epoxy groups, and optionally ester functions,
with at least one hardener (D) selected from carboxylic acids and acid anhydrides, and

optionally with at least one compound (C) comprising on the one hand at least one associative group, and on the other hand at least a function which permits its grafting on the precursor (P), on the curing agent (D) or on the product resulting from the reaction of (P) and (D),
in the presence of at least one transesterification catalyst.

Preferably, (C) is represented by the general formula:

A-L-R

wherein

A represents an associative group capable of forming hydrogen bonds,

L represents a linking arm, selected from aryl, aralkyl, alkane poly-yl, alkene poly-yl groups, optionally interrupted by one or more groups selected from an ether bridge, an amine bridge, a thioether bridge, an amide bridge, an ester bridge, a urea bridge, a urethane bridge, an anhydride bridge, a carbonyl bridge, and L can contain from 1 to 50 carbon atoms and up to 6 heteroatoms,

R represents a function selected from an alcohol (OH), an amine (NH, NH2), a carboxylic acid COOH.

The polymer composition, wherein the associative group is selected from those responding to one of the formulas (C′1), (C′2), (C′3), (C′4):

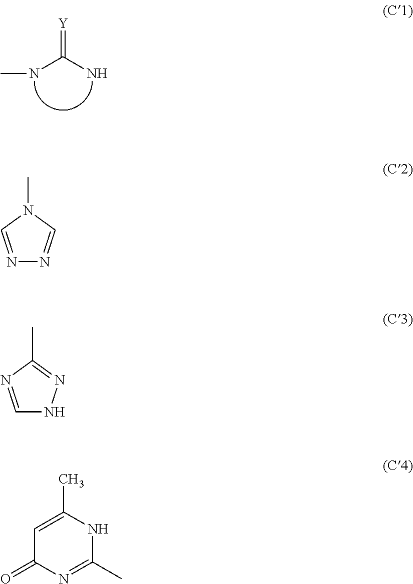

wherein Y is selected from O, S, or an NH group, in C′1, the bond represented by a circular arc between NH and N may be selected from: —CH2-CH2-, —CH═CH—, —NH—CH2-.

The polymer composition, wherein the total molar amount of transesterification catalyst is between 5% and 25% of the total molar amount of connecting ester bonds N_{E} contained in the polymer network.

The polymer composition, wherein the catalyst is chosen from metal salts, and preferably from salts of zinc, tin, magnesium, cobalt, calcium, titanium and zirconium.

The invention is also directed to a process for manufacturing an article based on a polymer composition as above disclosed, this process comprising:

i) the preparation of the polymer network composition by mixing the polymer network precursors, the catalyst and the thermally conductive charges in a one-step or sequential manner,

ii) the forming of the composition obtained from step i),

iii) the application of energy for hardening the polymer network composition,

iv) cooling of the hardened polymer network composition.

The invention is also directed to an article resulting from the forming and hardening of a polymer network composition as above disclosed.

According to favourite embodiments, the article is characterized by a transverse thermal conductivity superior or equal to 0.5 W·m⁻¹·K⁻¹.

The invention is also directed to a device comprising at least two adjoining or contacting parts:
at least one part (A) is an article as above disclosed,
at least one part (B) is of a material different from the material of (A), preferably (B) is of a metal.

Articles and devices which are above disclosed are advantagesouly selected from:
heat sinks for electronic components, especially in computers, consumer electrical appliances, solar cells and batteries, such as processors, lamps, LED-lamps, electric motors, thermic motors, electric circuits,
packing of electric or electronics elements, such as coils, chassis structures, housings or casings, for example solar cell back sheets, battery casings,
heat exchangers, like heat exchangers for energy transfer applications for example in transformers, or electrically insulating sheath for electric cables, geothermal heat exchangers, thermal pads.
coatings, like a varnish, a paint, an anticorrosion protective coat or a protective coat on an electronic circuit or an electronic component.
a seal or a layer of glue or adhesive.
   Further features and advantages of the invention will appear from the following description of embodiments of the invention, given as non-limiting examples, with reference to the accompanying drawings listed hereunder.

### DETAILED DESCRIPTION

A first object of the invention is a thermally conductive polymer composition comprising:
a) a thermally conductive filler having thermal conductivity superior or equal to 5 W/mK,
b) a covalently crosslinked polymer network including connecting ester bonds,
and
c) at least a transesterification catalyst,

wherein the amount of thermally conductive filler is sufficient for the composition to have thermal conductivity superior or equal to 0.5 W/mK, crosslinking is sufficient for the polymer network to be beyond the gel point and the number of connecting ester bonds is sufficient for the network to relax stresses and/or flow when conditioned at an appropriate temperature.

Thermally Conductive Filler:

The thermally conductive filler is selected among those having thermal conductivity superior or equal to 5 W/mK.

Intrinsic thermal conductivity of known fillers is based on values described in the literature, such as in “Thermal conductivity of Nonmetallic Solids,” Y. S. Touloukian, R. W. Powell, C. Y. Ho, and P. G. Klemans, IFI/Plenum: New York-Washington, 1970 or “Thermal Conductivity-Theory, Properties and Applications,” T. M. Tritt, Ed., Kluwer Academic/Plenum Publishers: New York, 2004.

Preferably, the thermally conductive filler has an intrinsic thermal conductivity greater than or equal to 10 W/mK, even more preferably greater than or equal to 25 W/mK, advantageously 50 W/mK. Examples of thermally conductive fillers include, but are not limited to, AlN (Aluminum nitride), BN (Boron nitride), MgSiN2 (Magnesium silicon nitride), SiC (Silicon carbide), Graphite, Ceramic-coated Graphite, Expanded graphite, Graphene, Carbon fiber, Carbon nanotube (CNT), or Graphitized carbon black, or a combination thereof.

Preferably, the thermally conductive filler is also electrically insulative, and is selected from fillers with a resistivity greater than or equal to 10⁵ Ohm·cm. Examples of thermally conductive, electrically insulative fillers include, but are not limited to, aluminum nitride, boron nitride, magnesium silicon nitride, silicon carbide, ceramic-coated graphite, or a combination thereof.

In addition, the composition may also contain a combination of electrically insulating and electrically conductive fillers provided that the amount of electrically conductive fillers is kept below the percolation threshold for electrical conductivity.

Example of thermally conductive and electrically conductive fillers include but are not limited to, metallic particles, expanded graphite, graphene, carbon fiber, carbon nanotube (CNT), or graphitized carbon black.

The threshold for electrical conductivity is the volume percentage at which the electrical conductivity increases by several orders of magnitude over a narrow concentration range. Its value depends on the shape, aspect ratio and state of aggregation of the electrically conductive particles considered. For each type of electrically conductive filler, the person skilled in the art knows how to determine the threshold for electrical conductivity in a given matrix and procedures are available in the literature. As shown for instance in Matthew L. Clingerman et al., Journal of Applied Polymer Science, 88(9), 2003, p. 2280, the conductivity of graphite filled composite materials raises from 10⁻¹⁴ to 10⁻² S·cm⁻¹ when graphite content is increased from ±12 to 25 vol % with regards to the total volume of the composition, respectively. Graphite particles in this case have an aspect ratio (length/diameter) of about 1.8 and the conductivity threshold found is 10.5% by volume with regards to the total volume of the composition, corresponding to 11.7% by volume with regards to the polymer volume. Lower conductivity thresholds are usually found with carbon black or with carbon nanotubes.

Preferably, the quantity of electrically conductive particles is less than two times the percolation threshold. In the particular case of graphite, the quantity of electrically conductive particles is preferably inferior or equal to 23.4% volume by volume of polymer network.

According to another embodiment, the polymer compositions and the articles according to the invention are also electrically conductive and are characterized by an electrical conductivity greater or equal to 0.1 S/cm. In this case, the amount of electrically conductive fillers should be taken greater than twice the threshold for electrical conductivity. Preferably, in the case of graphite, the amount of electrically conductive particles in this embodiment is equal or superior than 23.4% volume by volume of polymer network.

The amount of thermally conductive filler is sufficient for the composition to have thermal conductivity superior or equal to 0.5 W/mK. The thermal conductivity of the composition is measured using a TCi C-Therm thermal conductivity analyzer. The measurements were taken at room temperature on samples having a thickness of at least 1 mm and a surface at least large enough to completely cover the surface of contact of the 17 mm diameter probe.

Preferably, the composition comprises from 5% to 80% by volume of a thermally conductive filler as above disclosed, even more preferably from 10% to 60% by volume with regards to the volume of polymer network.

The amount of filler to obtain a desired thermal conductivity depends upon the filler itself and can be adjusted thanks to the above-indicated method for evaluation of thermal conductivity and to examples provided in the experimental part.

Polymer Network:

In all the description, by polymer is meant a homopolymer or a copolymer or a mixture of homopolymer and copolymer.

A network is formed when polymer chains are crosslinked in such a manner that there is a continuous path formed from a succession of monomers united by bridges, this path traversing the sample from end to end. When the polymer chains are crosslinked by a crosslinking agent, these monomers may originate from any of the network precursors: from the polymer chains and/or from the crosslinker. A person skilled in the art knows theoretical and/or empirical guides for determining the compositions that can produce a polymer network (cf. for example, P. J. Flory Principles of Polymer Chemistry Cornell University Press Ithaca-NY 1953).

The invention is related to polymer networks crosslinked through covalent crosslinkers. Non covalent bonds can also be present in the network, but, according to the invention, polymer crosslinking by covalent bonds should be present in a sufficient manner to form a polymer network.

In practice, the formation of a polymer network is ensured by a solubility test. It can be ensured that the polymer is beyond the gel point (i.e. a network has been formed) by placing the polymer network in a solvent known to dissolve non-crosslinked polymers of the same chemical nature. If the polymer swells instead of dissolving, the skilled professional knows that a network has been formed.

According to the invention, at least part of covalent bonds which constitute the polymer network are connecting ester bonds. Preferably, connecting ester bonds

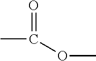

or bridges, represent from 2 to 30% by weight of the weight of the polymer network, even more preferably at least 4 to 25% by weight.

The quantity of connecting ester bonds is adjusted by the skilled professional by the appropriate selection of polymer network precursors (pre-polymers, monomers, cross-linkers).

Advantageously polymer networks used in the thermally conductive compositions according to the invention are characterized in that, when associated to the catalyst, there exists a temperature noted T₁, at or above which, under application of a 1% static strain, the polymer composition is able to relax at least 90% of stresses in less than 48 hours.

The measure of viscosity (and the quantitative evaluation of stress relaxation) is performed through torque measurements using a rheometer operating in the Ø=25 mm parallel planes geometry in the shear stress relaxation mode.

The viscosity η, expressed in Pa·s, is determined from stress relaxation experiments by using the formula:

η=σ₀×τ_{0.5}/γ

where
γ, a dimensionless number is the value of the applied strain, preferably equal to 0.01.
σ₀, expressed in pascals (Pa), is the value of stress measured within 1 second after application of the strain.
τ_{0.5}, expressed in seconds (s) is a value of time, measured from the instant when the strain has been applied for which the value of stress is equal to 50% (±2%) the value of the initial stress σ₀.

Preferably the sample for stress relaxation experiments is prepared by curing a liquid reactive mixture inside the rheometer in order to insure a good mechanical contact between the parallel plates and the sample. When it is not possible to prepare the sample for stress relaxation experiments inside the rheometer, for instance when strong gas evolutions occur or when the material is not obtained in its final form by heating a reactive liquid, disk-like specimens have to be prepared ex situ and adjusted inside the rheometer prior to stress relaxation experiments. In this case, the skilled professional knows how to check that there is actually a good mechanical contact between the sample and the parallel plates, for instance, by performing stress relaxation experiments at different values of strains or by performing rheological measurements in the oscillatory mode prior to stress relaxation experiments.

Polymer network compositions according to the invention are characterized in that there exists a temperature noted T₁, at or above which, under application of a static strain, the polymer composition is able to relax part or all of stresses in a finite delay (some minutes, some hours, some days), and at or above which the viscosity of the polymer network composition is of a finite value, notably inferior or equal to 10¹¹ Pa·s. T₁ is different for each polymer network composition.

It means that the polymer network can relax mechanical stresses and flow within a time scale which is short enough for this phenomenon to be noticed, measured and/or controlled, provided a proper catalyst (promoting ester bond exchange) is associated to the polymer network and under temperature conditioning.

The viscosity can be measured either by stress relaxation or creep experiments as described in the following references:
Montarnal, Damien; Capelot, Mathieu; Tournilhac, Francois; Leibler, Ludwik; Silica-Like Malleable Materials from Permanent Organic Networks, Science 2011, 334, 965; Capelot, Mathieu; Unterlass, Miriam M.; Tournilhac, Francois; Leibler, Ludwik; Catalytic Control of the Vitrimer Glass Transition, ACS Macro Let., 2012, 1, 789; Lu, Yi-Xuan; Tournilhac, Francois; Leibler, Ludwik; Guan, Zhibin; Making Insoluble Polymer Networks Malleable via Olefin Metathesis, J. Am. Chem. Soc. 2012, 134, 8424.

Advantageously, polymer networks used in the thermally conductive compositions according to the invention are characterized in that, when associated to the catalyst, there exists a temperature noted T₁, at or above which, under application of a static stress (expressed in Pa) numerically equal to three hundredth the value of the storage modulus (also expressed in Pa), the polymer composition is able to creep at least 3% in less than 48 hours.

Preferably the sample for creep experiments is prepared in the form of dogbone specimens and investigated in the tensile mode using a DMA or a tensile machine equipped with a heating stage. Precautions may be taken to avoid air oxidation, the creep is evaluated by considering the non-recoverable deformation occurring beyond the elastic deformation.

According to a particular embodiment, the polymer networks of the invention comprise:
Connecting ester bonds E, and
Reactive groups T capable of participating in a transesterification reaction with at least one bond E. Preferably T represents a hydroxy group. The polymer network comprises hydrocarbon chains comprising connecting ester bridges E, and advantageously OH groups and associative groups, which can be defined as capable of forming hydrogen bonds and which are detailed here-under. They can also contain bridges through one or several heteroatom like for instance ether bridges —O—.

Preferably, hydrocarbon chains, connecting ester bridges, ether bridges, OH groups, and associative groups represent at least 60% by weight of the weight of the polymer network, even more preferably at least 70% by weight, even better at least 80% by weight and advantageously at least 90% by weight, more advantageously at least 94% by weight, and even more advantageously at least 96% by weight.

According to a favorite variant, the polymer network consists essentially in hydrocarbon chains including connecting ester bridges, and optionally including ether bridges, OH groups, and associative groups.

Connecting Ester Bonds E

Polymer networks according to the invention include connecting ester bonds or bridges designated E. By connecting ester bonds is meant either main-chain bonds or crosslinking bonds. The network may be substituted by pendant chains through ester groups, however, these ester groups are not included in the definition of connecting ester bonds. When the polymer network comprises pending ester groups, preferably the number of T groups, which are preferably hydroxyl functions, should be superior to the number of pending ester groups.

Ester bonds are the result of, and can take part to, equilibrium reactions. Transesterification reactions, in the network compositions according to the invention, are reactions which can be fast enough to alter the properties of the network. In particular the polymer networks according to the invention are able to flow and/or to relax mechanical stress. Preferably, the time needed to relax 50 percent of an applied stress should be shorter than 10⁵ seconds provided a proper catalyst (promoting transesterification) is associated to the polymer network and under temperature conditioning.

According to the invention these connecting ester bonds E may be either main-chain bonds or crosslinking bonds: In both cases, they are part of the crosslinking system of the polymer network. The number of moles of connecting ester groups E in the network is designated N_{E}. The number of connecting ester bonds N_{E} can be directly deduced from the prepolymers, monomers and crosslinkers which are used to prepare the polymer network.

The number of moles of available reactive groups T in the network is designated N_{T.}

According to a variant N_{T}>0

Preferably according to this variant, N_{T}≧0.01N_{L}

Preferably, the number of connecting ester bonds N_{E} is superior or equal to 15% of the number of crosslinking points N_{C} in the network, even more preferably superior or equal to 20% of N_{C}. Advantageously, N_{E} is superior or equal to 30% N_{C}, even better N_{E} is superior or equal to 50% N_{C}. According to a favorite variant, N_{E} is superior or equal to 75% N_{C}, and preferably N_{E} is superior or equal to 90% N_{C}, even more preferably, N_{E} is superior or equal to 95% N_{C}.

The number of crosslinking points N_{C} can be calculated directly from the quantity and functionality of crosslinker(s) and/or the crosslinking method used in the formation of the polymer network.

Advantageously, the polymer network comprises less than 4% by weight of groups selected from —S—S— (disulfur) and —(S)ₙ— (polysulfur, n>2) bridges. Even more preferably, less than 2% by weight, better, less than 1% by weight, and even better less than 0.1% by weight of groups selected from —S—S— (disulfur) and —(S)ₙ— (polysulfur, n>2) bridges. According to a favorite variant, the polymer network comprises 0% by weight of groups selected from —S—S— (disulfur) and —(S)ₙ— (polysulfur, n>2) bridges.

The amount of —S—S— (disulfur) and —(S)ₙ— (polysulfur, n>2) bridges in the polymer network can be calculated and adjusted by the skilled professional by the appropriate selection of polymer network precursors (monomers, pre-polymers, crosslinkers).

Actually, the inventors have noted that the presence of such reactive groups in the network is prejudicial to the characteristics of the polymer network compositions, and especially, such reactive groups do not permit to obtain articles with high resistance to temperature, good adhesion and self-healing properties at high filler content.

Polymer Chains:

According to a favourite variant, the invention is implemented with polymer networks selected from thermosetting epoxy resins.

According to this favourite variant, the polymer network is obtained by contacting:

At least one thermosetting resin precursor (P), this thermosetting resin precursor (P) comprising hydroxyl functions and/or epoxy groups, and optionally ester functions,

with at least one curing agent or hardener (D) selected from carboxylic acids and acid anhydrides,

and

optionally with at least one compound (C) comprising on the one hand at least one associative group, and on the other hand at least a function which permits its grafting on the precursor (P), on the curing agent (D) or on the product resulting from the reaction of (P) and (D),

in the presence of at least one transesterification catalyst.

According to one variant, when the polymer network is based solely on compounds (P) and (D) and does not include component (C), the amount of hardener is chosen such that the resin is in the form of a network, and:

N_{O} denoting the number of moles of hydroxyl functions in the precursor,

Nₓ denoting the number of moles of epoxy groups in the precursor,

N_{A} denoting the number of moles of carboxylic acid functions of the hardener that are capable of forming a bond with a hydroxyl function or with an epoxy group of the thermosetting polymer precursor:

N_{A}<N_{O}+2Nₓ

When the hardener (D) is a dicarboxylic acid or an anhydride, it is capable of providing two acid functions per molecule and N_{A} is equal to twice the number of moles of hardener (D). When the hardener (D) is a tricarboxylic acid, it is capable of providing three acid functions per molecule and N_{A} is equal to three times the number of moles of hardener. Most of the time, the hardener (D) is a mixture of compounds of diverse functionalities and N_{A} must be calculated as a function of its composition.

Preferably, the amounts of reagents are chosen such that, after crosslinking, no unreacted epoxy functions remain.

This is reflected by the relationship N_{A}>Nₓ.

Precursor P:

For the purposes of the present invention, the term “thermosetting resin precursor (P)” means an oligomer, a prepolymer, a polymer or any macromolecule which, when reacted with a hardener (D), also known as a crosslinker or curing agent, in the presence of a source of energy, especially of heat, and optionally of a small amount of catalyst, gives a polymer network that has a solid structure. The invention more particularly concerns materials obtained by reacting thermosetting resin precursors with one or more hardeners, these materials comprising a) ester functions and b) hydroxyl functions.

These materials comprise ester functions and generally result from the polymerisation reaction between a hardener (D) comprising at least one polycarboxylic acid and a thermosetting resin precursor (P) comprising at least one epoxy function or one hydroxyl function. Other types of precursor and of hardener resulting in a resin bearing free hydroxyl groups and ester functions may be envisaged.

According to this variant of the invention, precursors (P) that comprise free hydroxyl functions and/or epoxy groups are selected. These free hydroxyl functions and epoxy groups are capable of reacting with the reactive functions of the hardener (D) to form a three-dimensional network maintained by connecting ester functions. It may be envisaged for the thermosetting resin precursor (P) itself to be in the form of a polyether or polyester chain that comprises hydroxyl functions and/or epoxy groups capable of participating in a crosslinking reaction in the presence of a hardener (D). It may also be envisaged for the thermosetting resin precursor (P) to be in the form of an acrylic or methacrylic resin comprising epoxy groups.

Preferably, the invention relates to thermosetting resins of epoxy type. Thus, advantageously, the precursor (P) is an epoxy resin precursor. Advantageously, the epoxy resin precursor represents at least 10% by weight of the weight of the precursor (P), advantageously at least 20%, preferably at least 40% and most preferably at least 60%.

A thermosetting epoxy resin precursor is defined as a molecule containing more than one epoxy group. The epoxy group also known as oxirane or ethoxyline, is shown in the formula below:

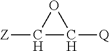

In which Q=H or Q=Z′, Z and Z′ representing hydrocarbon groups.

There are two major categories of epoxy resin: epoxy resins of glycidyl type, and epoxy resins of non-glycidyl type. Epoxy resins of glycidyl type are themselves classified into glycidyl ether, glycidyl ester and glycidyl amine. Non-glycidyl epoxy resins are of aliphatic or cycloaliphatic type.

Glycidyl epoxy resins are prepared via a condensation reaction of the appropriate dihydroxy compound with a diacid or a diamine and with epichlorohydrin. Non-glycidyl epoxy resins are formed by peroxidation of the olefinic double bonds of a polymer.

Among the glycidyl epoxy ethers, bisphenol A diglycidyl ether (BADGE) represented below is the one most commonly used.

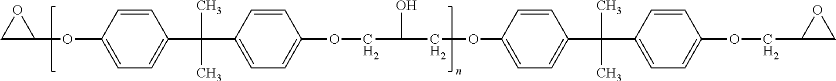

BADGE-based resins have excellent electrical properties, low shrinkage, good adhesion to numerous metals, good moisture resistance, good heat resistance and good resistance to mechanical impacts.

The properties of BADGE resins depend on the value of n, which is the degree of polymerisation, which itself depends on the stoichiometry of the synthesis reaction. As a general rule, n ranges from 0 to 25.

Novolac epoxy resins (whose formula is represented below) are glycidyl ethers of novolac phenolic resins. They are obtained by reacting phenol with formaldehyde in the presence of an acid catalyst to produce a novolac phenolic resin, followed by a reaction with epichlorohydrin in the presence of sodium hydroxide as catalyst.

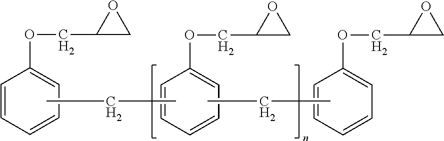

Novolac epoxy resins generally contain several epoxide groups. The multiple epoxide groups make it possible to produce resins with a high crosslinking density. Novolac epoxy resins are widely used for formulating moulded compounds for microelectronics on account of their superior resistance to high temperature, their excellent mouldability, and their superior mechanical, electrical, heat-resistance and moisture-resistance properties.

The epoxy resins to which the invention applies may be any of those provided that their precursors comprise, before reaction with the carboxylic acid, a mean number of epoxide and hydroxyl functions per precursor such that:

2<2<n_{X}>+<n_{O}>

This inequality should be considered in the strict sense.

<n_{X}> being the numerical mean of the number of epoxy functions per precursor,

<n_{O}> being the numerical mean of the number of hydroxyl functions per precursor.

The numerical mean is defined by:

<n>=sum(P(i)*i)/sum(P(i)), where P(i) is the number of molecules containing i functions.

Preferably, 3≦2<n_{X}>+<n_{O}>

Even more advantageously, 4≦2<n_{X}>+<n_{O}>

The thermosetting resin precursor that may be used in the present invention may be chosen especially from: novolac epoxy resins, bisphenol A diglycidyl ether (BADGE), bisphenol F diglycidyl ether, tetraglycidyl methylene dianiline, pentaerythritol tetraglycidyl ether, tetrabromobisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropyleneglycol diglycidyl ether, terephthalic acid diglycidyl ester, epoxidised polyunsaturated fatty acids, epoxidised plant oils, epoxidised fish oils and epoxidised limonene, and mixtures thereof.

Advantageously, it is chosen from: BADGE, epoxidized soja oil and novolac resins.

Hardener (D):

A hardener is necessary to form a crosslinked three-dimensional network from an epoxy resin. A wide variety of hardeners exists for epoxy resins. The agents commonly used for crosslinking epoxides are amines, polyamides, polycarboxylic acids, phenolic resins, anhydrides, isocyanates and polymercaptans. The reaction kinetics and the glass transition temperature, Tg, of the crosslinked resin depend on the nature of the hardener. The choice of resin and of hardener depends essentially on the desired application and properties. The stoichiometry of the epoxy-hardener system also affects the properties of the hardened material.

Preferably, the resin according to the present invention is manufactured with at least one hardener (D) chosen from carboxylic acids.

Hardeners of the carboxylic acid class are typically used to obtain flexible materials (moderately crosslinked networks with a low Tg).

Carboxylic acids react with epoxide groups to form esters. The presence of at least two carboxylic acid functions on the hardener compound is necessary to crosslink the resin. On account of exchange reactions, the presence of two carboxylic acid functions on the hardener compound is sufficient to form a three-dimensional network. Activation with a catalyst is necessary.

According to one variant of the invention, the hardener(s) (D) are used in an amount that is sufficient to consume all the free epoxy functions of the resin. According to one preparation method, a hardener of acid type may especially be used in stoichiometric amount relative to the epoxy resin precursor (P) such that all the epoxy functions have reacted with the acid.

The preparation of the resin according to the invention may be performed with one or more hardeners, including at least one of polyfunctional carboxylic acid type. Advantageously, the hardener is chosen from: carboxylic acids in the form of a mixture of fatty acid dimers and trimers comprising 2 to 40 carbon atoms.

As acids that may be used in the invention, mention may be made of carboxylic acids comprising 2 to 40 carbon atoms, such as linear diacids (glutaric, adipic, pimelic, suberic, azelaic, sebacic or dodecanedioic and homologues thereof of higher masses) and also mixtures thereof, or fatty acid derivatives. It is preferred to use trimers (oligomers of 3 identical or different monomers) and mixtures of fatty acid dimers and trimers, in particular of plant origin. These compounds result from the oligomerization of unsaturated fatty acids such as: undecylenic, myristoleic, palmitoleic, oleic, linoleic, linolenic, ricinoleic, eicosenoic or docosenoic acid, which are usually found in pine oil, rapeseed oil, corn oil, sunflower oil, soybean oil, grapeseed oil, linseed oil and jojoba oil, and also eicosapentaenoic acid and docosahexaenoic acid, which are found in fish oils.

As acids that may also be used in the invention, mention may be made of aromatic carboxylic acids comprising 2 to 40 carbon atoms, like aromatic diacids such as phtalic acid, trimellitic acid, terephtalic acid, naphtalenedicarboxylic acid.

Examples of fatty acid trimers that may be mentioned include the compounds of the following formulae that illustrate cyclic trimers derived from fatty acids containing 18 carbon atoms, given that the compounds that are commercially available are mixtures of steric isomers and of positional isomers of these structures, which are optionally partially or totally hydrogenated.

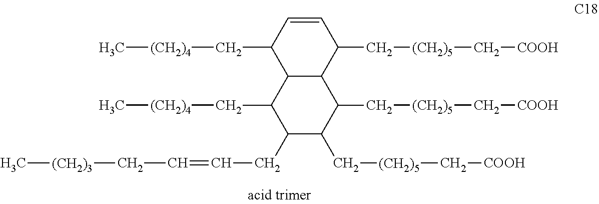

A mixture of fatty acid oligomers containing linear or cyclic C₁₈ fatty acid dimers, trimers and monomers, the said mixture predominantly being dimers and trimers and containing a small percentage (usually less than 5%) of monomers, may thus be used. Preferably, the said mixture comprises:
0.1% to 40% by weight and preferably 0.1% to 5% by weight of identical or different fatty acid monomers,
0.1% to 99% by weight and preferably 18% to 85% by weight of identical or different fatty acid dimers, and
0.1% to 90% by weight and preferably 5% to 85% by weight of identical or different fatty acid trimers.

Examples of fatty acid dimers/trimers that may be mentioned include (weight %):
Pripol® 1017 from Uniqema or Croda, mixture of 75-80% dimers and 18-22% trimers with about 1-3% fatty acid monomers,
Pripol® 1048 from Uniqema or Croda, 50/50% mixture of dimers/trimers,
Pripol® 1013 from Uniqema or Croda, mixture of 95-98% dimers and 2-4% trimers with 0.2% maximum of fatty acid monomers,
Pripol® 1006 from Uniqema or Croda, mixture of 92-98% dimers and a maximum of 4% trimers with 0.4% maximum of fatty acid monomers,
Pripol® 1040 from Uniqema or Croda, mixture of fatty acid dimers and trimers with at least 75% trimers and less than 1% fatty acid monomers,
Unidyme® 60 from Arizona Chemicals, mixture of 33% dimers and 67% trimers with less than 1% fatty acid monomers,
Unidyme® 40 from Arizona Chemicals, mixture of 65% dimers and 35% trimers with less than 1% fatty acid monomers,
Unidyme® 14 from Arizona Chemicals, mixture of 94% dimers and less than 5% trimers and other higher oligomers with about 1% fatty acid monomers,
Empol® 1008 from Cognis, mixture of 92% dimers and 3% higher oligomers, essentially trimers, with about 5% fatty acid monomers,
Empol® 1018 from Cognis, mixture of 81% dimers and 14% higher oligomers, essentially trimers, with about 5% fatty acid monomers,
Radiacid® 0980 from Oleon, mixture of dimers and trimers with at least 70% trimers.

The products Pripol®, Unidyme®, Empol® and Radiacid® comprise C₁₈ fatty acid monomers and fatty acid oligomers corresponding to multiples of C₁₈.

As diacids that may be used in the invention, mention may also be made of polyoxyalkylenes (polyoxyethylene, polyoxypropylene, etc.) comprising carboxylic acid functions at their ends, phosphoric acid, polyesters and polyamides, with a branched or unbranched structure, comprising carboxylic acid functions at their ends.

Preferably, the hardener is chosen from: fatty acid dimers and trimers and polyoxyalkylenes comprising carboxylic acids at the ends.

The hardener(s) of carboxylic acid type may be used alone or as a mixture with other types of hardener, especially hardeners of amine type and hardeners of acid anhydride type.

A hardener of amine type may be chosen from primary or secondary amines containing at least one NH₂ function or two NH functions and from 2 to 40 carbon atoms. This amine may be chosen, for example, from aliphatic amines such as diethylenetriamine, triethylenetetramine, tetraethylenepentamine, dihexylenetriamine, cadaverine, putrescine, hexanediamine, spermine, isophorone diamine, and also aromatic amines such as phenylenediamine, diaminodiphenylmethane, diaminodiphenyl sulfone and methylenebischlorodiethylaniline.

Advantageously, when an amine hardener is used in the mixture, the amine/epoxy ratio is limited so that, in the absence of connecting ester bonds, the tertiary amine bonds thus created are not sufficient to pass the gel point. In practice, a person skilled in the art can rely on the vast literature existing on epoxy-amine systems to select the appropriate composition. The test described below which concerns the formation of a network may be used to check that the gel point is not exceeded:

In a material, it is considered that the gel point is not reached as long as a cylindrical post made from this material, with an initial height of approximately 1 cm at room temperature and a diameter of 1 cm, after having been left for 10 hours at a temperature of 100° C. and then equilibrated for 30 minutes at room temperature, has a final height that differs by more than 20% from the initial height.

A hardener of anhydride type may be chosen from cyclic anhydrides, for instance phthalic anhydride, methylnadic anhydride, hexahydrophthalic anhydride, dodecylsuccinic anhydride or glutaric anhydride.

Mention may also be made of succinic anhydride, maleic anhydride, chlorendic anhydride, nadic anhydride, tetrachlorophthalic anhydride, pyromellitic dianhydride, 1,2,3,4-cyclopentanetetracarboxylic acid dianhydride, and aliphatic acid polyanhydrides such as polyazelaic polyanhydride and polysebacic polyanhydride.

Advantageously, when one or more hardeners other than a carboxylic acid is used as a mixture with the hardener(s) of carboxylic acid type, the acid represents at least 10 mol %, preferably at least 20 mol %, advantageously at least 40 mol % and better still at least 60 mol % relative to the hardeners (D) as a whole.

According to the invention, the hardener (D) is used in an amount sufficient to form a network. In particular, an acid hardener is used in an amount sufficient to form a network based on ester bridges.

In practice, the formation of a network is ensured if, after formation of the ester bridges, a cylindrical post made of this material, with an initial height of approximately 1 cm at room temperature and a diameter of 1 cm, after having been left for 10 hours at a temperature of 100° C. and then equilibrated for 30 minutes at room temperature, has a final height differing by less than 20% from the initial height.

When a precursor comprising at least two epoxy functions per molecule, and a hardener comprising at least two carboxylic acid functions, are used, using an equimolar ratio of acids and of epoxy, the conditions already stated are sufficient to obtain a network:

N_{A}<N_{O}+2Nₓ

N_{A}>Nₓ

Polymer networks which can be used in the invention also include thermoset/supramolecular hybrid composites and resins, resulting from bringing at least one thermosetting resin precursor (P), this thermosetting resin precursor comprising hydroxyl functions and/or epoxy groups, and optionally ester functions, into contact with at least one hardener (D) chosen from carboxylic acids and acid anhydrides, and with at least one associative monomer (C).

Associative Monomer (C):

According to a variant, the polymer network is obtained, in addition to epoxy precursors (P) and hardeners (D), from monomers selected from compounds (C) comprising on the one hand at least one associative group, and on the other hand at least a function which permits its grafting on the precursor (P), on the curing agent (D) or on the product resulting from the reaction of (P) and (D)

In the context of the invention, “function permitting its grafting on the thermosetting resin precursor (P), on the hardener (D) or on the product resulting from the reaction of (P) and (D)” means advantageously a function permitting the covalent grafting of the compound (C) on one of these entities. This compound (C) may be selected as follows:

By “associative groups” is meant groups likely to associate with each other by bonds selected from hydrogen bonds, Π bonds (aromatic), ionic bonds and/or hydrophobic bonds. Preferably the associative group is selected from those likely to associate by forming hydrogen bonds. Preferably, when thermoset epoxy resins are used, in compound (C), associative group(s) is (are) linked via a spacer arm to a function chosen from the functions which are reactive with carboxylic acids, with the epoxy groups or with alcohol functions.

Compound (C) may be advantageously represented by the following general formula:

A-L-R

wherein

A represents an associative group,

L represents a linking arm,

R represents a function selected from a function R₁ reactive with carboxylic acids, or a function R₂, reactive with epoxy functions or with alcohol functions.

Among functions reactive with carboxylic acids, R₁, there may be mentioned alcohol functions (OH) and amine (NH, NH2). Among functions R₂, reactive with epoxy or alcohol groups, may be mentioned carboxylic acids. Preferably R is NH2 or COOH.

Preferably the spacer L is selected from aryl, aralkyl, alkane poly-yl, alkene poly-yl groups, optionally interrupted by one or more groups selected from an ether bridge, an amine bridge, a thioether bridge —S—, an amide bridge, an ester bridge, a urea bridge, a urethane bridge, an anhydride bridge, a carbonyl bridge.

L can contain from 1 to 50 carbon atoms and up to 6 heteroatoms.

Preferably, A is selected from associative groups capable of forming hydrogen bonds. Advantageously, A is selected from groups capable of associating with each other by 1 to 6 hydrogen bonds.

Among associative groups, mention may be made particularly of those of formulas (C1), (C2), (C3) and (C4):

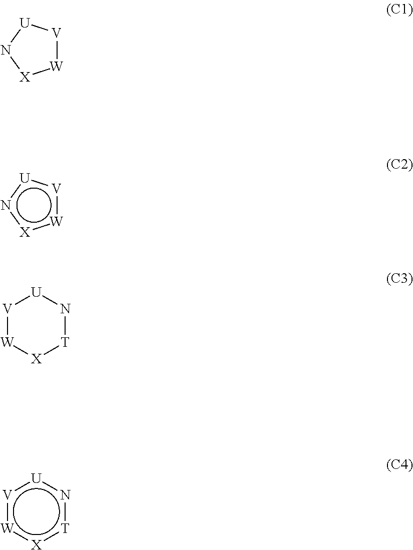

Wherein U, V, W, X, T, identical or different, represent a group chosen from: N, NH, CH, C—CH3, C═O, C═NH, C═O, at least one of U, V, W and X is N or NH, the bonds between N, U, V, W, X may be single bonds, double bonds and optionally may form an aromatic ring (as in C2 and C4).

The binding of the associative group (C1), (C2), (C3) and (C4) with the linker L may be made via a nitrogen atom or a carbon atom of any cycle.

Specific examples of associative groups are:

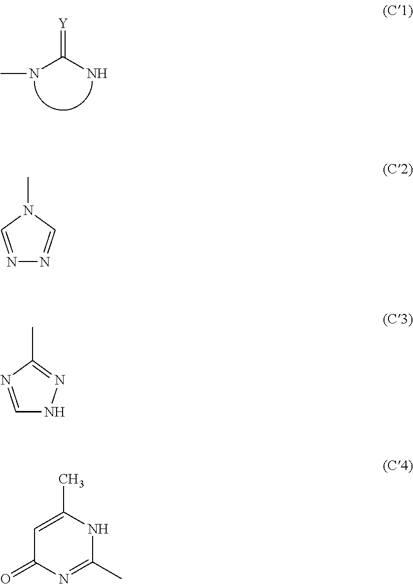

wherein Y is selected from O, S, or an NH group.

In C′1, the bond represented by a circular arc between NH and N may be selected from: —CH2-CH2-, —CH═CH—, —NH—CH2-.

Among associative groups known in the art mention may be made of imidazolidinyl, triazolyl, triazinyl, bis-ureyl, and ureido-pyrimidyl groups.

Other particular examples are the ureido pyrimidone derivatives, such as 2-((6-aminohexylamino-)carbonylamino)-6-methyl-4 [1H]-pyrimidinone (UPY).

Preferred associative groups are imidazolidone, triazolyl and ureido-pyrimidone.

Preferably, compound (C) is selected from the following molecules:

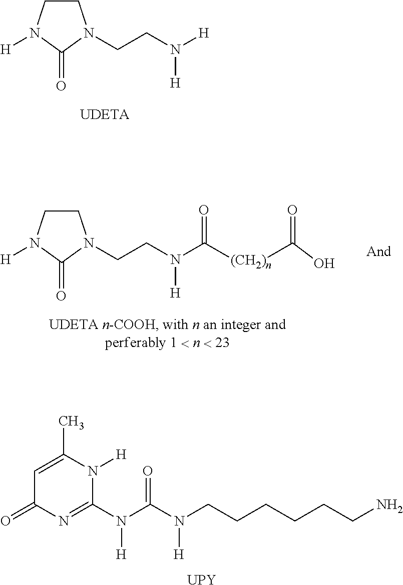

The proportions of the various components of the hybrid resin are preferably adjusted to obtain the expected properties.

Preferably, the amount of curing agent or hardener (D) is selected so that the resin is in the form of a network.

Preferably, the following conditions are met:

N_{O} is the number of moles of hydroxyl functional groups in the precursor (P),

Nₓ is the number of moles of epoxy groups in the precursor (P),

N₁ is the number of moles of groups R₁ in compound (C).

N₂ is the number of moles of R₂ groups in compound (C).

N_{A} is the number of moles of carboxylic acid functions of the hardener (D) capable of forming a bond with a hydroxyl function or with an epoxy group of the precursor (P) polymer:

N_{A}−N₁<2N_{X}+N_{O}−N₂

Most of the time, the hardener is a mixture of compounds of various features and N_{A} must be calculated according to the acid mixture used.

Preferably quantities of reagents are selected so that after curing there is no unreacted epoxy function remaining.

This is reflected in the relationship: N_{A}−N₁>Nₓ−N₂

Advantageously, N₁ and N₂ having the same definition as above, N₁+N₂ is the number of moles of compound (C) having associative groups in the resin composition of the invention, N₁ and N₂ satisfy the following two propositions:
N₁>0.01 N_{A} or N₂>0.01 N_{B}
N₁<0.9 N_{A} and N₂<0.9 N_{B}

Wherein N_{B} is the number of alcohol and/or epoxy functions from the precursor (0) capable of reacting with R₂.

Preferably only one of the two numbers N₁ and N₂ is different from zero.

According to a preferred embodiment of the invention, compound (C) is obtained by reacting:

at least one polyfunctional carboxylic acid compound as described above under the category of hardeners (D),

with

an associative molecule having a functional group reactive with carboxylic acids.

For example, compound (C) can be obtained by reacting at least one polyfunctional carboxylic acid compound with at least one compound (c*) responding to the formula below:

A-L′-R′

(c*)

Wherein

A represents an associative group,

L′ is a linker arm, for example a C1-C12 alkane di-yl group, optionally interrupted by one or more bridges selected from ether bridges, amine bridges,

R′ represents a function capable of reacting with a carboxylic acid, such as an OH function or a NH2 function.

For example (c*) can be chosen from the following compounds: 2-aminoethylimidazolidone (UDETA), 1-(2-[(2-aminoethyl)amino]ethyl)imidazolidone (UTETA), 1-(2-{2-[(2-aminoethylamino]ethyl}amino)ethyl]imidazolidone (UTEPA), 3-amino-2,4-triazole (3-ATA) and 4-amino-1,2,4-triazole (4-ATA).

Advantageously, according to this embodiment, part of the acid hardener (D) is first reacted with the compound (c*) comprising associative groups, the proportion of compound (c*) being such that only a portion of the acid hardener (D) reacts with (c*).

Advantageously, the reaction is carried out under conditions such that the polycarboxylic acid hardener (D) generally retain at least one free carboxylic acid function, not linked to (c*).

This yields a mixture of unreacted hardener (D), and compound (C), derived from the reaction of (D) with (c*) and comprising at least one carboxylic acid function. This mixture is brought into contact with the thermosetting resin precursor (P) under conditions permitting the reaction of free acid functions of the curing agent or hardener (D) and free acid functions of compound (C) with the epoxide and alcohol functional groups of the resin precursor (P).

According to a manner of implementing this alternative embodiment, compound (c*) can be reacted with a first polyacid hardener (D1) to obtain a compound (C) having at least one free carboxylic acid function. In a second step, this compound (C) is then reacted with precursor (P) in the presence of a second polyacid hardener (D2) identical to or different from the first hardener, under conditions permitting the reaction of the acid hardeners, (D1) and (D2), and acid functions of the compound (C) with the alcohol and epoxide functions of the resin precursor (P).

According to this embodiment wherein compound (C) is obtained by reacting at least one poly-functional carboxylic acid compound, as described above under the category of hardeners, with an associative molecule having a functional group reactive with carboxylic acids, the amount of compound (c*) is selected such that 5 to 75% of the acid functions of the total amount of acid hardener (D) reacts with (c*), preferably from 5 to 50%, and preferably from 10 to 30%.

According to another embodiment of the invention, the precursor (P) can be reacted with the hardener (D) under conditions allowing the reaction of the free acid functions of the hardener (D) with the epoxy and alcohol functions of the precursor (P). Then, in a second stage, compound (C) is introduced in the mixture, under conditions permitting the reaction of the reactive functions of compound (C) with the alcohol functions of the resin precursor (P) or with the acid functions of the hardener (D). In this case, compound (C) may have as reactive functions: COOH or OH or NH₂ functions.

Preferably, the polymer network is based on the reaction of resin precursors (P), hardeners (D) and compounds (C) which have been above disclosed, and does not comprise other types of monomers and/or prepolymers.

Transesterification Catalyst:

In addition to a thermally conductive filler and a polymer network as above-disclosed, the composition comprises at least one catalyst capable of promoting the transesterification reaction. Advantageously, the transesterification catalyst is introduced in the mixture used to prepare the polymer network. In some cases, for example when the polymer network is a thermoset epoxy resin, the exchange reaction catalyst is also a catalyst of the network formation reaction.

Preferably, the transesterification catalysts are used in the invention in an amount ranging from 5 mol % to 25 mol % relative to the total molar amount of connecting ester bonds E, N_{E}, contained in the polymer network.

Advantageously, when the polymer network is based on epoxy resin and the catalyst is a transesterification catalyst, the total molar amount of transesterification catalyst is between 5% and 25% of the total molar amount of epoxy, N_{X} contained in the thermosetting resin precursor (P).

Advantageously, “transesterification catalyst” means a compound that satisfies the test disclosed in WO2011/151584 and US 2011/319524 ([0127]-[0141], FIG. 2 and FIG. 3).

The catalyst may be selected from:
Catalysts of organic nature, such as: guanidines, such as triazabicyclodecene amidines (TBD), pyridines such as 4-pyrrolidinopyridine, dimethylaminopyridine;
Metal salts, rare earth salts, alkali metal and alkaline earth, including:
   salts of Zn, Sn, Mg, Co, Ca, Ti and Zr as acetylacetonates especially cobalt acetylacetonate, samarium acetylacetonate;
   tin compounds such as dibutyltinlaurate, tin octoate, dibutyltin oxide, dioctyltin, dibutyldimethoxytin, tetraphenyltin, tetrabutyl-1,3-dichlorodistannoxane and all other stannoxanes;
   rare earth salts of alkali metals and alkaline earth metals, particularly rare earth acetates, alkali metal and alkaline earth metal such as calcium acetate, zinc acetate, tin acetate, cobalt acetate, nickel acetate, lead acetate, lithium acetate, manganese acetate, sodium acetate, cerium acetate;
   salts of saturated or unsaturated fatty acid and metal, and alkali metal, alkaline earth and rare earth, such as zinc stearate;
Metal oxides such as zinc oxide, antimony oxide, indium oxide;
Metal alkoxides such as titanium tetrabutoxide, titanium propoxide, titanium isopropoxide, titanium ethoxide, zirconium alkoxides, niobium alkoxides, tantalum alkoxides;
Alkali metal, alkaline earth metal and rare earth alcoholates and metal hydroxides, such as sodium alcoholate, such as sodium methoxide, potassium alkoxide, lithium alkoxide;
Sulfonic acids including: sulfuric acid, methane sulfonic acid, paratoluene sulfonic acid;
Phosphines including: triphenylphosphine, dimethylphenylphosphine, methyldiphenylphosphine, triterbutylphosphine;
Phosphazenes.

In the above mentioned list, all catalysts are appropriate to catalyze a transesterification reaction.

Advantageously, the transesterification catalyst is selected from those having transesterification kinetics similar to that of the metal salts of zinc, tin, magnesium, cobalt, calcium, titanium and zirconium, particularly acetylacetonates of said metals, when used in a transesterification reaction.

These catalysts are generally in solid form and in this case, advantageously in the form of a finely divided powder.

One can use a heterogeneous catalyst, that is to say, a catalyst which is not in the same phase as the reactants, but advantageously one uses a homogeneous catalyst, present in the same phase as the reactants.

Preferably, the transesterification catalyst is dissolved in the monomer mixture, or in the precursor polymer (P) or in the crosslinker (D).

The transesterification catalyst, solid or liquid, is preferably soluble in the monomer mixture, or in the precursor polymer (P).

Preferably, the transesterification catalyst is chosen from metal salts, and more specifically from salts of zinc, tin, magnesium, cobalt, calcium, titanium and zirconium.

Other Components

Polymer compositions comprising at least one polymer network whose characteristics have been described above may further comprise: one or more polymers, pigments, dyes, fillers, plasticizers, fibres, flame retardants, antioxidants, lubricants, wood, glass, metals, compatibilizing agents.

Among the polymers that may be used in mixture with the polymer networks of the invention, mention may be made of: elastomers, thermosets, thermoplastic elastomers, impact additives.

The term “pigments” means coloured particles that are insoluble in the polymer network. As pigments that may be used in the invention, mention may be made of titanium oxide, carbon black, carbon nanotubes, metal particles, silica, metal oxides, metal sulfides or any other mineral pigment; mention may also be made of phthalocyanins, anthraquinones, quinacridones, dioxazines, azo pigments or any other organic pigment, natural pigments (madder, indigo, crimson, cochineal, etc.) and mixtures of pigments. The pigments may represent from 0.05% to 75% by weight relative to the weight of the material.

The term “dyes” means molecules that are soluble in the polymer network and that have the capacity of absorbing part of the visible radiation.

Among the additional fillers that may be used in the polymer network composition of the invention, mention may be made of: silica, clays, calcium carbonate, carbon black, kaolin, whiskers.

The presence in the polymer network compositions of the invention of fibres such as glass fibres, carbon fibres, polyester fibres, polyamide fibres, aramid fibres, cellulose and nanocellulose fibres or plant fibres (linseed, hemp, sisal, bamboo, etc.) may also be envisaged.

Compatibilizing agents are selected among components which permit easier dispersion of the fillers, notably the thermally conductive fillers, in the polymer network precursors, like the prepolymers and/or monomers and/or the crosslinkers. As an example, the fillers may be treated with silane or siloxane coupling agents or with epoxy amines or the like in order to enable better matrix-filler interfacial strengths and dispersion.

Preferably, components, including thermally conductive fillers, are selected so that the thermally conductive polymer composition is also electrically insulating.

Method for the Preparation of the Composition:

The thermally conductive filler having thermal conductivity superior or equal to 5 W/mK and/or the catalyst can be introduced into the polymer network.

According to a favourite variant, the composition is directly prepared from the reactants. The reactants can be monomer compositions, polymer precursors, crosslinkers (also named hardeners).

According to this variant, preferably, the catalyst, solid or liquid, is solubilized in one of the components of the reaction, and the thermally conductive filler is also dispersed or suspended in one of the components of the reaction. The catalyst can be solubilized in the precursor polymer and then the catalyst/precursor mixture is put into contact with the crosslinker. Or the catalyst is solubilized in the crosslinker, in some cases it can react with the crosslinker, and then the catalyst/crosslinker mixture is put into contact with the precursor polymer. Or the catalyst is solubilized in the monomer composition including the crosslinker.

The thermally conductive filler is advantageously dispersed in the precursor polymer.

The invention is also related to objects or articles resulting from processing a composition as above disclosed. Such a processing generally includes a curing step, which is performed at an adapted temperature according to the nature of the polymer chains, so that the gel point is reached or exceeded.

A subject of the invention is also a process for manufacturing an article based on a thermally conductive polymer composition as described above, this process comprising:

a) the preparation of the polymer network composition by mixing the components in a one-step or sequential manner,

b) the forming of the composition obtained from step a),

c) the application of energy for hardening the polymer network composition,

d) cooling of the hardened polymer network composition.

The word “components” in the method designates the polymer network precursors (monomers, prepolymers, crosslinkers or hardeners), the catalyst and the thermally conductive charges. The placing in contact of the components may take place in a mixer of any type known to those skilled in the art. The term “application of energy for hardening the polymer network composition” generally means raising the temperature. The application of energy for hardening the polymer network composition in step c) of the process may consist, in a known manner, of heating at a temperature of from 50 to 250° C. The cooling of the hardened polymer network composition is usually performed by leaving the material to return to room temperature, with or without use of a cooling means.

The process is advantageously performed in conditions such that the gel point is reached or exceeded at the end of step d). Especially, the process according to the invention advantageously includes the application of sufficient energy at step c) for the gel point of the polymer network to be reached or exceeded.

According to a favourite variant, the catalyst is first dissolved in the composition comprising the crosslinker, generally by heating with stirring, the thermally conductive charge is introduced in the polymer precursor and the two compositions are then mixed together.

In the context of the invention, “forming” includes a variety of methods, which are detailed here-under in a non limitative manner.

Usually, an article based on a covalently crosslinked polymer network composition is manufactured by mixing one or several of the following components: monomers or polymer precursor, crosslinker, fillers, catalyst and additives, introduction in a mould and raising the temperature. The means for manufacturing such an article are well known to those skilled in the art.

However, by means of the covalently crosslinked polymer network compositions of the invention, other methods for forming the article than moulding may be envisaged, such as filament winding, continuous moulding or film-insert moulding, infusion, pultrusion, RTM (resin transfer moulding), RIM (reaction-injection moulding) or any other method known to those skilled in the art, as described in the publications “Epoxy Polymer”, edited by J. P. Pascault and R. J. J. Williams, Wiley-VCH, Weinheim 2010 or “Chimie industrielle”, by R. Perrin and J. P. Scharff, Dunod, Paris 1999.

It is also possible to mix the thermally conductive fillers into the uncured resin precursor mixture, optionally with solvent, spin coating the resulting mixture onto the support as a film, and then evaporating the solvent and curing the resin. Spin coating can create finer thicknesses with good thickness control, achieved by tailoring viscosity, spinning revolutions per minutes (rpm), composite volume, etc. . . . . Films on the order of 5-10 μm or less may be coated using these techniques.

Articles

An article resulting from the forming and hardening of the polymer network composition described above also forms part of the invention.

For the purposes of the present invention, the term “article” means a component based on a material comprising a thermally conductive polymer network composition as described above. The article is made of a composite material. Advantageously, in the articles according to the invention, the gel point of the polymer network is reached or exceeded.

The articles according to the invention may also consist of coatings that are deposited on a support, for instance a protective layer or a paint. They may also consist of an adhesive material.

Articles obtained from curing a thermally conductive polymer composition according to the invention are advantageously characterized by a transverse thermal conductivity superior or equal to 0.5 W·m⁻¹·K⁻¹, preferably superior or equal to 1 W·m⁻¹·K⁻¹, even more preferably superior or equal to 1.5 W·m⁻¹·K⁻¹. The thermal conductivity of the composition is measured using a TCi C-Therm thermal conductivity analyser. The measurements are taken at room temperature on samples having a thickness of at least 1 mm and a surface at least large enough to completely cover the surface of contact of the 17 mm diameter probe

Preferably, the polymer compositions and the articles according to the invention are also electrically insulating, and are characterized by a resistivity greater than or equal to 10⁶ Ohm·cm, preferably greater than or equal to 10⁹ Ohm·cm.

Volume resistivity is measured from films or rods by cutting the sample on both ends using a razor blade or notching a sample bar on both ends followed by a cold-fracture at −60° C. The cut or fractured surfaces are treated with silver paint and dried. The resistance through the sample is measured in the 2-probes mode under constant applied voltage, U using a nanoamperemeter to yield the volume resistivity (in Ohm·m) which is determined from:

Volume Resistivity=(U/I)*(S/l),

where I is the current flowing through the sample, S is the section of the sample and l is the sample length.

According to another embodiment, the polymer compositions and the articles according to the invention are also electrically conductive and are characterized by a conductivity greater or equal to 0.1 S/cm. Volume conductivity is measured from films or rods by cutting the sample on both ends using a razor blade or notching a sample bar on both ends followed by a cold-fracture at −60° C. Volume conductivity (in Siemens/cm) is measured by the four-probe method under constant applied current, I to yield the volume conductivity determined from: volume conductivity=(I/U)*(l/S), where U is the voltage measured across the two inner probes, S is the section of the sample and 1 is the distance between the two inner probes.

The invention is of particular interest for devices comprising at least two adjoining parts: a thermally conductive polymer part and another part of a material like metal, glass, aluminium, silicium. More specifically, the invention is directed to devices comprising at least a metal part and a thermally conductive polymer part, wherein both parts are adjoining or in contact. Such contact may be of any type: the thermally conductive polymer part may be adhered on the metal (like for example a coating or a thermal pad of thermally conductive resin on a metal piece) or both parts may be fixed to each other with mechanical means like rivets or spikes, or both parts may be juxtaposed in a close proximity like metal cables in a thermally conductive polymer sheath, the thermally conductive polymer sheath itself being surrounded by a metal electrode. In such devices, the thermally conductive polymer part is based on the polymer composition according to the invention and its function generally is heat transfer. The thermally conductive polymer part can also fulfil other functions like electrical insulator between two electrodes, support for the fixation of electronic components or electrical components or casing for electronic or electrical components. The thermally conductive polymer part, when applied as a coating, can also have the function of protecting the support to which it is applied (metal parts of an engine, die backside) from scratches and shocks. In geothermal applications, the material can be used to produce heat exchangers, such as pipes, with improved thermal conductivity, notably on account of a better conformability to the well's walls, and which consequently can be of reduced length. One advantage of the material according to the invention is its adhesion properties which reveal upon heating and remain after cooling. Therefore, the material can be used, as thermal pad for example, without the need for any mechanical fixation means, or with only limited mechanical fixation means.

The invention is particularly directed to articles and devices selected from:
heat sinks for electronic components, especially in computers, consumer electrical appliances, solar cells and batteries, such as processors, lamps, LED-lamps, electric motors, thermic motors, electric circuits,
packing of electric or electronics elements, such as coils, chassis structures, housings or casings, for example solar cell back sheets, battery casings,
heat exchangers, like heat exchangers for energy transfer applications for example in transformers, or electrically insulating sheath for electric cables, geothermal heat exchangers, or thermal pads.

and also as
coatings for all kinds of materials, especially metals, like a varnish, a paint, an anticorrosion protective coat or a protective coat on an electronic circuit or an electronic component.
a seal or a layer of glue or adhesive.

As will be illustrated in the examples below, such articles have longer life-time when compared to prior art articles, since the material regenerates, or self-heals, without any human intervention, and recovers its cohesion and most of its properties, notably thermal transfer, upon thermal activation. Aging signs, or mechanical damages, which lead to the disruption of the thermal transfer, like cracks, gaps, gas bubbles, delamination and failures, are significantly reduced, and/or are erased, and/or their apparition is significantly delayed by the simple application of heat for a sufficient time. The material is able to self-recover intrinsic cohesive damages. The material is able to self-recover its bulk thermal conduction properties after any cohesive damage. The self-healing thermal interface material according to the invention is capable of self-recovering its adhesive properties on other materials by application of heat. The material according to the invention can bear higher temperature variations than prior art materials without undergoing degradation. The material according to the invention provides adaptability to other materials of varied thermal expansion coefficient, including metals, even when the material is applied as a thin coating. All these properties permit the restauration of the thermal path upon use (heating) of the material. As compared to disulfide self-healing thermally conductive resins, the materials according to the invention provide improved thermal resistance, improved adhesion, improved self-healing, even at high thermally conductive filler content.

Upon use, under thermal activation, the material adapts to better fit with, or conform to, the shapes of other materials with which it is contacted, resulting in improved thermal transfer. Upon heating, the material actually tends to fill interfacial voids and gaps. This is an advantage especially when the materials to which they are associated present a rough and/or irregular surface, or a thinly carved profile. Surprisingly, the material can be submitted to higher temperatures than prior art thermally conductive polymer materials. This property permits improvements in energy transport: current transport is limited for cables of a given section due to the Joule effect which produces temperature rises and the limited capacity of prior art materials to evacuate heat. Transport of current of higher intensity can be envisioned thanks to the TIM according to the invention.

The material according to the invention present adhesive properties on metal, ceramics, silicon, and these properties can be quantified from 0.2 to 20 Kg·cm². It can be processed into thin films allowing to reduce thermal impedance. The material can be mounted with very low mounting force if the temperature is locally increased during mounting. It provides structure support and avoids the use of clamp during mounting.

Transformation and Recycling

The articles based on polymer network compositions according to the invention, on account of their particular composition, can be transformed, repaired and recycled by raising the temperature of the article. They also have the advantage that their viscosity can be controlled so that they can be transformed by using other technical means than molding. The mechanical properties of such materials are characterized below and illustrate the innovative nature of the invention. These properties are conserved even after transformation of these materials by a process as described above (application of a mechanical constraint and temperature elevation).

Below the glass transition temperature Tg, the polymer is vitreous and has the behaviour of a rigid solid with an elastic storage modulus of between 10⁸ and 10¹⁰ Pa. Above the Tg temperature and below T₁, it has viscoelastic behaviour over a broad temperature range, with a storage modulus at 1 Hz of between 1×10⁵ and 5×10⁸ Pa according to the composition. From a practical point of view, this means that, within a broad temperature range, the article can be deformed with improved viscosity control. In particular, they can be thermoformed.

The transesterification reactions are the cause of the relaxation of constraints and of the variation in viscosity at high temperatures. In terms of application, these materials can be processed at high temperatures, where a low viscosity allows injection or moulding in a press. It should be noted that, contrary to Diels-Alder reactions, no depolymerisation is observed at high temperatures and the material maintains its covalently crosslinked structure. In all cases, the polymer's processability is improved: The polymer networks can have more flexible and controlled modes of transformation thanks to a better control of the viscosity and plasticity of the network.

The exchange reactions allow the repair of two parts of an article. No mould is necessary to maintain the shape of the components during the repair process at high temperatures. Similarly, components can be transformed by application of a mechanical constraint to only one part of an article without the need for a mould, since the material does not flow under its own weight. However, large-sized components, which have more of a tendency to collapse, can be maintained by a support frame, as in the case of glassworking.

Another subject of the invention is thus a process for transforming at least one article made from a material as described above, this process comprising: the application to the article of a mechanical constraint at a temperature (T) above room temperature. Preferably, in order to enable transformation within a time that is compatible with industrial application of the process, the process comprises the application to the article of a mechanical constraint at a temperature (T) superior or equal to the glass transition temperature Tg of the material of which the article is composed, advantageously at a temperature (T) superior or equal to the temperature T₁ of the material of which the article is composed.

Usually, such a process is followed by a step of cooling to room temperature, optionally with application of at least one mechanical constraint.

For the purposes of the present invention, the term “mechanical constraint” means the application of a mechanical force, locally or to all or part of the article, this mechanical force tending towards forming or deforming the article. Among mechanical constraints that may be used, mention may be made of: pressure, moulding, blending, extrusion, blow-moulding, injection-moulding, stamping, twisting, flexing, pulling and shearing.

It may be, for example, twisting applied to a strip of material of the invention. It may be a pressure applied by means of a plate or a mould onto one or more faces of an article of the invention, stamping a pattern in a plate or sheet made of material of the invention. It may also be a pressure exerted in parallel onto two articles made of materials of the invention in contact with each other so as to bring about bonding of these articles. In the case where the article consists of granules of material of the invention, the mechanical constraint may consist of blending, for example in a blender or around an extruder screw. It may also consist of injection-moulding or extrusion. The mechanical constraint may also consist of blow-moulding, which may be applied, for example, to a sheet of material of the invention. The mechanical constraint may also consist of a plurality of separate constraints, of identical or different nature, applied simultaneously or successively to all or part of the article or in a very localised manner.

This transformation may include mixing or agglomeration with one or more additional components chosen from: one or more polymers, pigments, dyes, fillers, plasticizers, fibres, flame retardants, antioxidants, lubricants, wood, glass or metals.

Assembling, bonding and repair are particular cases of the transformation process described above.

This raising of the temperature of the article may be performed by any known means such as heating by conduction, convection, induction, spot heating, infrared, microwave or radiant heating. The means for bringing about an increase in temperature of the article in order to perform processing of the article comprise: an oven, a microwave oven, a heating resistance, a flame, an exothermic chemical reaction, a laser beam, a hot iron, a hot-air gun, an ultrasonication tank, a heating punch, etc.

Thanks to exchange reactions the material does not flow during the transformation, by selecting an appropriate temperature, heating time and cooling conditions, the new shape may be free of any residual constraint. The material is thus not embrittled or fractured by the application of the mechanical constraint. Furthermore, the component will not return to its first shape. Specifically, the transesterification reactions that take place at high temperature promote a reorganisation of the polymer network so as to cancel out mechanical constraints. A sufficient heating time makes it possible to completely cancel these mechanical constraints internal to the material that have been caused by the application of the external mechanical constraint.

According to one variant, a subject of the invention is a process for obtaining and/or repairing an article based on a thermally conductive polymer composition, comprising:
at least one step (a) of curing a thermally conductive covalently crosslinked polymer network composition to form an article,
a step (b) of placing at least two articles as obtained in step (a) in contact, and
a step (c) of applying a temperature (T) above room temperature so as to obtain a single article.

According to the invention, the temperature (T) during step (b) is chosen within the range from 50° C. to 250° C. and preferably from 100° C. to 200° C.

An article made of material of the invention may also be recycled: either via direct treatment of the article: for example, the broken or damaged article is repaired by means of a transformation process as described above and may thus regain its prior working function or another function; or the article is reduced to particles by application of mechanical grinding, and the particles thus obtained may then be used in a process for manufacturing an article. In particular, according to this process, particles of material of the invention are simultaneously subjected to a rising of temperature and a mechanical constraint allowing them to be transformed into an article, while controlling the viscosity of the composition.

The mechanical constraint that allows the transformation of particles into an article may, for example, comprise compression in a mould, blending or extrusion.

This method thus makes it possible, by applying a sufficient temperature and an appropriate mechanical constraint, to mould articles from the thermally conductive polymer composition material, while controlling the viscosity of the material. Especially, it makes it possible to mould articles from the material based on thermally conductive polymer network composition having reached or exceeded the gel point.

Another advantage of the invention is that it allows the manufacture of materials made of thermally conductive polymer network compositions, in the form of elemental components or units based on thermally conductive polymer network compositions having reached or exceeded the gel point: particles, granules, beads, rods, plates, sheets, films, strips, stems, tubes, etc. via any process known to those skilled in the art. These elemental components may then be transformed under the combined action of heat and of a mechanical constraint into articles of the desired shape, while controlling the viscosity of the composition: for example, strips may, by stamping, be chopped into smaller pieces of chosen shape, sheets may be superposed and assembled by compression.

A subject of the invention is thus a process for manufacturing at least one article based on thermally conductive polymer compositions, which is a particular case of the transformation process already described, this process comprising:

a) the use as starting material of a material or article of the invention in the form of an elemental unit or an assembly of elemental units,

b) the simultaneous application of a mechanical constraint and a conditioning of the article at a temperature T to form the article,

c) cooling of the article resulting from step b).

Especially at step a), the material or article of the invention is advantageously based on thermally conductive polymer network compositions having reached or exceeded the gel point.

After use, articles can be reconditioned in the form of elemental units or components and then reformed again according to the invention.

One subject of the invention is thus a process for recycling an article made of material of the invention, this process comprising:

a) the use of the article as starting material,

b) the application of a mechanical constraint, and optionally of a simultaneous increase of temperature, to transform this article into an assembly of elemental units,

c) cooling of this assembly of elemental units.

Especially at step a), the article is advantageously based on thermally conductive polymer network compositions having reached or exceeded the gel point

The term “elemental units” means components that have a standardised shape and/or appearance that are suited to their subsequent transformation into an article, for instance: particles, granules, beads, rods, plates, sheets, films, strips, stems, tubes, etc. The term “assembly of elemental units” means at least two elemental units, better still at least three, even better still at least 5, preferentially at least 10, even more preferentially at least 100, advantageously at least 10³, even more advantageously at least 10⁴ and preferentially at least 10⁵.

One significant advantage of the thermally conductive polymer network compositions according to the invention, as compared to prior art compositions that are not based on exchangeable bonds is that their two characteristic temperatures (Tg, and Tf) and their behaviour around or above T₁ permit fine tuning of the composition's viscosity. And these characteristic temperatures can be adapted to selected values by the selection of appropriate monomers and/or polymer precursors, crosslinkers and catalysts.

The invention has been described with reference to preferred embodiments. However, many variations are possible within the scope of the invention.

### EXPERIMENTAL PART

### A—Material Synthesis

### I-1 Example 1

### Synthesis of Material (1-05) Incorporating a Catalyst According to the Invention

First Step: Solubilization of the Catalyst and Ligand Exchange

In a 100 mL flask, 20 g Pripol® 1040 (dicarboxylic: 23 wt %, tricarboxylic: 77 wt %; carboxylic acid molar equivalent weight 296 g/eq.) and 742 mg of zinc acetate dihydrate is added (3.47 mmol), thus a molar ratio [Zn]/[COOH] of 0.05. The mixture is heated under vacuum step by step from 110° C. to 170° C. for 3 hours until complete dissolution of the catalyst. A vigorous evolution of gas was observed, confirming the release of the acetate ligands and their replacement by fatty acids.

Second Step: Reaction with Epoxy Resin

In a Teflon beaker, was added 15.75 g of the mixture prepared in the first step with 9.25 g of DGEBA (epoxy molar equivalent weight: 174 g/eq.), thus a molar ratio [COOH]/[epoxy] close to 1). The reaction mixture is homogenized by heating (−130° C.) under mechanical stirring. The mixture is then poured into a mold made of a 1.4 mm thick brass plate having a 100 mm×100 mm rectangular hole, placed between two sheets of anti-adhesive paper and pressed under a pressure of 10 MPa at 130° C. for 4 h. IR spectroscopic analysis shows the disappearance of the ν_{C=0} band of the acid at 1705 cm⁻¹ as well as the δ_{C-O-C} band (vibration ring) of the epoxy at 915 cm⁻¹ and the appearance of the ν_{C═O} band of the ester at 1735 cm⁻¹.

### I-2—Synthesis of Material (1-10) Incorporating a Catalyst According to the Invention

The same protocol as in §I-1 is used with a molar ratio [Zn]/[COOH] of 0.10.

### I-3—Comparative Example 1

### Synthesis without Catalyst (Material (1-00)

The same protocol as in §I-1 is used. In a Teflon beaker, 15.75 g Pripol® 1040 and 9.25 g of DGEBA (stoichiometric ratio acid/epoxy) are placed. The reaction mixture is homogenized by heating (−130° C.) under mechanical stirring. The mixture is then placed in the mold under the press (pressure 10 MPa) at 130° C. for 24 h. After demoulding, a post-cure is performed in a vacuum oven at 130° C. for an additional 24 hours. IR spectroscopic analyzes show that as before the reaction is complete.

### II-1 Example 2

### Synthesis of Material (2-05) Incorporating UDETA and a Catalyst

First Step: Reaction of UDETA with the Fatty Acid

In a reactor, 196.4 g of Pripol® 1040 was introduced and then 27.4 g UDETA [molar mass 129.2 g/mol], thus a molar ratio [NH2]/[COOH] of 30%. The reaction is carried out under mechanical stirring under a nitrogen sweep (˜320 mL/min) at 150° C. IR spectroscopic analysis confirms the decrease of the ν_{C=0} band of the acid at 1705 cm⁻¹ and the appearance of the the ν_{C=0} band of the amide at 1650 cm⁻¹. The reaction is stopped when these bands do not vary anymore, i.e. after about 2 h 30. Analysis by ¹H and ¹³C NMR confirmed the complete reaction of the amine groups.

Second Step: Solubilization of the Catalyst

In a 250 ml flask, 82.53 g of the mixture synthesized in the first step is introduced together with 1.85 g of zinc acetate dihydrate (8.43 mmol), thus a molar ratio of [Zn]/[COOH] remaining 0.05. The mixture is heated under vacuum gradually from 110° C. to 170° C. After 3 hours, the catalyst appears completely dissolved.

Third Step: Reaction with the Epoxy Resin

In a Teflon beaker, was added 19.11 g of the mixture prepared in the second step with 6.92 g of DGEBA (epoxy molar equivalent weight: 174 g/eq.), thus a molar ratio [COOH]/[epoxy] close to 1). The reaction mixture is homogenized by heating (−130° C.) under mechanical stirring. The mixture is then poured into a mold made of a 1.4 mm thick brass plate having a 100 mm×100 mm rectangular hole, placed between two sheets of anti-adhesive paper and pressed under a pressure of 10 MPa at 130° C. for 12 h. IR spectroscopic analysis shows the total disappearance of the ν_{C=0} band of the acid at 1705 cm⁻¹ as well as the δ_{C-O-C} band (vibration ring) of the epoxy at 915 cm⁻¹ and the appearance of the ν_{C═O} band of the ester at 1735 cm⁻¹.

### II-2 Example 2Bis

### Synthesis of Material (2-10) Incorporating UDETA and a Catalyst

The same protocol as in §II-1 is used but in the second step, the amount of zinc acetate dihydrate is 16.86 mmol, thus the molar ratio of [Zn]/[COOH] is 0.10.

### II-3—Comparative Example 2

### Synthesis without Catalyst (Material (2-00)

The same protocol as in §II-1 is used but in which the second step is omitted.

### Example III

### Synthesis of a Material Incorporating a Matrix, a Catalyst and Fillers

### III-1 The Synthesis Protocol is Illustrated Through the Preparation of Material (1-10) Incorporating a Catalyst and 30 Vol % Fillers According to the Invention

First Step: Solubilization of the Catalyst and Ligand Exchange

In a 100 mL flask, 20 g Pripol® 1040 (dicarboxylic: 23 wt %, tricarboxylic: 77 wt %; carboxylic acid molar equivalent weight 296 g/eq.) and 742 mg of zinc acetate dihydrate is added (3.47 mmol), thus a molar ratio [Zn]/[COOH] of 0.1. The mixture is heated under vacuum step by step from 110° C. to 170° C. for 3 hours until complete dissolution of the catalyst. A vigorous evolution of gas was observed, confirming the release of the acetate ligands and their replacement by fatty acids.

Second Step: Incorporation of the Fillers:

In a Teflon beaker 15.75 g of the mixture prepared in the first step was added. To this mixture, a desired amount of filler is added to reach a desired volume percentage taking into account the total volume of the polymeric matrix. The mixture is homogenized by heating (˜90° C.) under mechanical stirring. The total volume of the polymeric matrix (Vₘₐₜᵣᵢₓ) is calculated adding the volume of the polymeric component added in the first step taking into account its mass (15.75 g) and its nominal density (ρ=1.1 g/cm3) and the volume of the component (DGEBA) added in the second step taking into account its mass (9.25 g) as describe in §I-1 and its nominal density (ρ_{DGEBA}=1.17 g/cm3).

The mass of filler to be added to reach a 30 vol % composition is calculated according to the following:

M_{filler}=ρ_{filler}·Vₘₐₜᵣᵢₓ·(0.3)/(1−0.3)

Where

Vₘₐₜᵣᵢₓ=(15.75/1.1)+(9.25/1.17)

Third Step: Reaction with Epoxy Resin

To the mixture prepared in the second step, 9.25 g of DGEBA is added (epoxy molar equivalent weight: 174 g/eq.), thus a molar ratio [COOH]/[epoxy] close to 1). The reaction mixture is homogenized by heating (˜90° C.) under mechanical stirring. The mixture is then poured into a mold made of a 1.4 mm thick brass plate having a 100 mm×100 mm rectangular hole, placed between two sheets of anti-adhesive paper and pressed under a pressure of 10 MPa at 130° C. for 4 h. IR spectroscopic analysis shows the disappearance of the ν_{C=0} band of the acid at 1705 cm⁻¹ as well as the δ_{C-O-C} band (vibration ring) of the epoxy at 915 cm⁻¹ and the appearance of the ν_{C═O} band of the ester at 1735 cm⁻¹.

### III-2. The Same Protocol is Used for the Production of Materials Incorporating Other Matrixes and Other Fillers

### B—Test Protocols

Test Protocol No. 1: Material Recycling

Material synthesized in Part A is cut in small pieces. These pieces are gathered and placed between two sheets of anti-adhesive paper in a mold of a 1.4 mm thick brass plate having a 100 mm×100 mm rectangular hole and hot pressed at 150° C. for 20 minutes under a pressure of 10 MPa.

Test Protocol No. 2: Conductivity Measurements:

The following setup is preferred whenever the resistance of the samples is lower than 200 MOhms.

A film of a doped material synthesized in Part A is cut using a razor blade to make a rectangular sample of dimensions: length=2.4 cm, width=0.9 cm, thickness=0.14 cm metallized at both ends using electrically conductive silver glue. The electrical conductance is measured using a Keithley 2400 sourcemeter operating in 1 mA applied current in the 4-wire sensing mode. Whereas the two outer probes are connected to the metallized surfaces, the two inner probes are connected to contact tips placed at two different points of the center line of the sample. The electrical resistivity displayed on the device is used to determine the bulk conductivity r, according to:

σ=(1/R)×(1/S)

The average value of ten measurements by making the inner contacts at different points gives the value of conductivity.

Test Protocol No. 3: Resistivity Measurements:

The following setup is preferred whenever the resistance of the samples is equal or higher than 200 MOhms.

A film of the material is cut using a razor blade to make a rectangular sample of typical dimensions: length=2.5 cm, width=1 cm, thickness=0.1 cm metallized at both ends using electrically conductive silver glue. The electrical resistance is measured using a Keithley 616 ammeter operating in one of the 10⁻⁶-10⁻¹² ampere ranges. The measurement is performed in the 2-wires mode using a HP6516A high voltage generator as a dc source. The value of the current, I flowing through the sample is measured 1 minute after application of the constant dc voltage.

Each value reported below is the mean of four measurements performed at U=+200, −200, +200 and −200 volts.

The electrical bulk conductivity p is determined according to:

ρ=(U/I)×(S/l)

where S is the section of the sample and l the length of the sample (distance between both metallized surfaces).

Test Protocol No. 4: Thermal Conductivity Measurement:

Film of samples of materials doped with different volume % of graphite with a nominal thickness at least equal to 1 mm and a circular surface area with a diameter at least greater than 17 mm were used for thermal conductivity measurement. The thermal conductivity measured using a TCi CTherm thermal conductivity analyzer.

Test Protocol No. 5: Adhesion Recovery:

Samples of materials doped with different volume % of filler or material were used as adhesive in a standard single lap shear test according to ASTM 1002D. For samples preparation, a film of the material is cut using a razor blade to make a rectangular sample of typical dimensions: length=12.5 mm, width=25 mm, thickness=1 mm is sandwiched between two identical support with an overlap length of 12.5 mm. Aluminum alloy 6082-T6 plates of typical dimensions: length=100 mm, width=25 mm and thickness=2 mm were used as support.

The adhesion was promoted by a 2 h thermal treatment at 100° C. During the thermal treatment the adhesive and the two parts of the sample were kept in contact using a paper clip.

Single lap shear test were performed using Zwick/Roell 250 tensile tester with an elongation speed of 1 mm/min. The tests were stopped after complete failure meaning that the bond line has been broken and the two aluminum plates were completely separated. After the failure, the sample ends were repositioned carefully to recover the same bond area and the thermal treatment was repeated followed by the lap shear test using the same protocol. Each thermal treatment that aim to promote the recovery of adhesion is denoted as an adhesion recovery cycle. For each sample at least 5 adhesion recovery cycles were performed.

### C—Results

Material Recycling (Protocol No. 1)

| | | | Thermal |
|---|---|---|---|
| | | | conductivity |
| Matrix | Filler | vol % filler | (W · m⁻¹ · K⁻¹) |
| Material (1-10) virgin | A1N | 20 | 0.62 |
| Material (1-10) recycled | A1N | 20 | 0.57 |

This data shows that composite materials according to the invention can be reprocessed and keep its initial thermal conductivity property as well as its mechanical property. In comparison, reference materials using matrices 1-00 do not show any recycling ability and thus it was not possible to measure the thermal conductivity due to lack of suitable sample size and shape.

Resistivity Measurements (Protocol No. 3):

| | | | resistivity | |
|---|---|---|---|---|
| Matrix | Filler | vol % filler | (Ohm · cm) | |
| material (1-10) | Graphite | 20% | 10 (±4) | 10⁶ |
| material (2-10) | Graphite | 20% | 6.6 | 10⁶ |
| material (2-10) | Boron nitride | 40% | 1.5 | 10¹⁰ |
| material (1-10) | Aluminum | 20% | 2.7 | 10¹⁰ |
| | nitride | | | |

This data shows that it is possible to design composite materials according to the invention, showing a high resistivity by using non conductive loadings or by using conductive loadings at volume concentrations below the percolation threshold for electric conductivity.

Thermal Conductivity Measurement (Protocol No. 4):

| | | | Thermal |
|---|---|---|---|
| Matrix | Filler | vol % filler | conductivity (W · m⁻¹ · K⁻¹) |
| material (1-10) | — | 0% | 0.27 |
| material (1-10) | Graphite | 10% | 0.74 |
| material (1-10) | Graphite | 20% | 1.07 |
| material (1-10) | Graphite | 30% | 1.45 |
| material (2-10) | — | 0% | 0.28 |
| material (2-10) | Graphite | 20% | 0.91 |
| material (2-10) | Graphite | 50% | 4.28 |

Adhesion Recovery (Protocol No. 5):

| | | vol % | |
|---|---|---|---|
| Matrix | Filler | filler | Adhesive Strength (MPa) |
| material (1-00) | — | 0% | 0 |
| material (1-10) | — | 0% | 1.00 ± 0.40 |
| material (1-10) | Graphite | 30% | 0.85 ± 0.10 |
| material (2-00) | — | 0% | 0.6 ± 0.20 |
| material (2-10) | — | 0% | 2.90 ± 1.00 |
| material (2-10) | Graphite | 20% | 2.40 ± 0.45 |
| material (2-10) | Graphite | 50% | 0.62 ± 0.10 |
| material (2-10) | Aluminum Nitride | 20% | 3.45 ± 0.40 |
| material (2-10) | Boron Nitride | 40% | 3.61 ± 0.40 |

This data shows that in normal conditions of use where the thermally conductive film is exposed to the heat, articles made of the composite material according to the invention show adhesive strength recovery. This property is maintained at relatively high loadings. In comparison, reference materials using matrices 1-00 and 2-00 show inferior adhesive strength recovery.

1. Polymer composition comprising:
a) a thermally conductive filler having thermal conductivity superior or equal to 5 W/mK,
b) a covalently crosslinked polymer network including connecting ester bonds, and
c) at least a transesterification catalyst,
wherein the amount of thermally conductive filler is sufficient for the composition to have thermal conductivity superior or equal to 0.5 W/mK, crosslinking is sufficient for the polymer network to be beyond the gel point and the number of connecting ester bonds is sufficient for the network to relax stresses and/or flow when conditioned at an appropriate temperature.

2. Polymer composition according to claim 1, wherein the thermally conductive filler is electrically insulative.

3. Polymer composition according to claim 2, wherein the thermally conductive filler is selected from: aluminum nitride, boron nitride, magnesium silicon nitride, silicon carbide, ceramic-coated graphite, and combinations thereof.

4. Polymer composition according to claim 1, wherein the composition comprises from 5% to 80% by volume of a thermally conductive filler, preferably from 10% to 60% by volume with regards to the volume of polymer network.

5. Polymer composition according to claim 1, wherein the polymer network comprises hydrocarbon chains comprising connecting ester bridges, ether bridges, OH groups, and associative groups, and wherein hydrocarbon chains, connecting ester bridges, ether bridges, OH groups, and associative groups represent at least 60% by weight of the weight of the polymer network.

6. Polymer composition according to claim 5, wherein the polymer network consists essentially in hydrocarbon chains including connecting ester bridges.

7. Polymer composition according to claim 6, wherein the polymer network further includes ether bridges, OH groups, and associative groups.

8. Polymer composition according to claim 1, wherein the polymer network including connecting ester bonds is obtained by contacting:
At least one thermosetting resin precursor (P), this thermosetting resin precursor (P) comprising hydroxyl functions and/or epoxy groups, and optionally ester functions,
with at least one hardener (D) selected from carboxylic acids and acid anhydrides,
and
optionally with at least one compound (C) comprising on the one hand at least one associative group, and on the other hand at least a function which permits its grafting on the precursor (P), on the curing agent (D) or on the product resulting from the reaction of (P) and (D),
in the presence of at least one transesterification catalyst.

9. Polymer composition according to claim 8, wherein
(C) is represented by the general formula:
A-L-R
wherein
A represents an associative group capable of forming hydrogen bonds,
L represents a linking arm, selected from aryl, aralkyl, alkane poly-yl, alkene poly-yl groups, optionally interrupted by one or more groups selected from an ether bridge, an amine bridge, a thioether bridge, an amide bridge, an ester bridge, a urea bridge, a urethane bridge, an anhydride bridge, a carbonyl bridge, and L can contain from 1 to 50 carbon atoms and up to 6 heteroatoms,
R represents a function selected from an alcohol (OH), an amine (NH, NH2), a carboxylic acid COOH.

10. Polymer composition according to claim 9, wherein the associative group is selected from those responding to one of the formulas (C′1), (C′2), (C′3), (C′4): 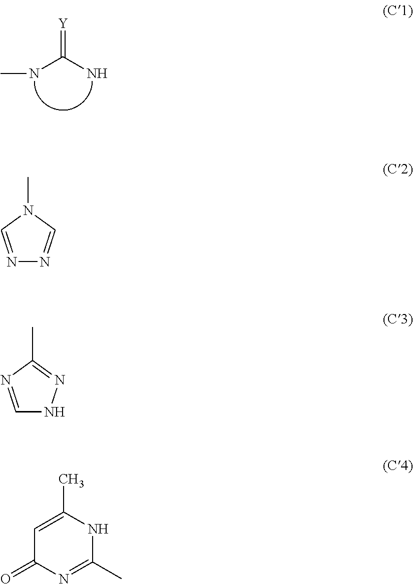
wherein Y is selected from O, S, or an NH group, in C′1, the bond represented by a circular arc between NH and N may be selected from: —CH2-CH2-, —CH═CH—, —NH—CH2-.

11. Polymer composition according to claim 1, wherein the total molar amount of transesterification catalyst is between 5% and 25% of the total molar amount of connecting ester bonds N_{E} contained in the polymer network.

12. Polymer composition according to claim 1, wherein the catalyst is chosen from metal salts.

13. Polymer composition according to claim 12, wherein the catalyst is chosen from salts of zinc, tin, magnesium, cobalt, calcium, titanium and zirconium.

14. Polymer composition according to claim 1, wherein the polymer network comprises less than 4% by weight of groups selected from —S—S— (disulfur) and —(S)ₙ— (polysulfur, n>2) bridges.

15. An article resulting from the forming and hardening of a polymer network composition according to claim 1.

16. An article according to claim 15, characterized by a transverse thermal conductivity superior or equal to 0.5 W·m⁻¹·K⁻¹.

17. Device comprising at least two adjoining or contacting parts:
at least one part (A) is an article according to claim 15,
at least one part (B) is of a material different from the material of (A), preferably (B) is of a metal.

18. Articles and devices according to claim 15 selected from:
heat sinks for electronic components, especially in computers, consumer electrical appliances, solar cells and batteries, such as processors, lamps, LED-lamps, electric motors, thermic motors, electric circuits,
packing of electric or electronics elements, such as coils, chassis structures, housings or casings, for example solar cell back sheets, battery casings,
heat exchangers, like heat exchangers for energy transfer applications for example in transformers, or electrically insulating sheath for electric cables, geothermal heat exchangers, thermal pads.
coatings, like a varnish, a paint, an anticorrosion protective coat or a protective coat on an electronic circuit or an electronic component.
a seal or a layer of glue or adhesive.
